(19) United States
(12) Patent Application Publication
(10) Pub. No.: US 2024/0281639 A1
(43) Pub. Date: Aug. 22, 2024

(54) COMPLEX CLIPPING FOR IMPROVED GENERALIZATION IN MACHINE LEARNING

(71) Applicant: The Covid Detection Foundation d/b/a Virufy, Los Altos, CA (US)

(72) Inventors: Les Atlas, Seattle, WA (US); Ankit Virmani, Seattle, WA (US); Nicholas R. Rasmussen, Sioux Falls, SD (US); Mert Pilanci, Los Altos, CA (US); Felix Schwock, Seattle, WA (US)

(73) Assignees: The Covid Detection Foundation d/b/a Virufy, Los Altos, CA (US); University of Washington, Seattle, WA (US); Stanford University, Stanford, CA (US)

(21) Appl. No.: 18/584,936

(22) Filed: Feb. 22, 2024

Related U.S. Application Data
(60) Provisional application No. 63/447,532, filed on Feb. 22, 2023.

(51) Int. Cl. G06N 3/04

(52) U.S. Cl. CPC G06N 3/04

(57) ABSTRACT

Provided is a method including obtaining time-series data; computing a transform of the time-series data; performing, with a complex clipping algorithm, a complex clipping operation of the transform of the time-series data to obtain a clipped data representation of the transform; classifying, using a classifier, the time-series data based on the clipped data representation; and storing a result of the classifying in memory.

### CROSS-REFERENCE TO RELATED APPLICATIONS

This patent application claims priority to U.S. Provisional Patent Application 63/447,532 filed 22 Feb. 2023, titled “COMPLEX CLIPPING FOR IMPROVED GENERALIZATION IN MACHINE LEARNING.” The entire content of each afore-mentioned patent filing is hereby incorporated by reference.

### GOVERNMENT LICENSE RIGHTS

This invention was made with government support under Contract No. 75A50122C00034 awarded by Department of Health and Human Services; Office of the Assistant Secretary for Preparedness and Response; Biomedical Advanced Research and Development Authority. The government has certain rights in the invention.

### 1. FIELD

The present disclosure relates generally to machine learning, and more specifically to using complex clipped data of time-series data to make classifications.

### 2. DESCRIPTION OF THE RELATED ART

In recent years, the field of machine learning and artificial intelligence (AI) has witnessed significant advancements, revolutionizing various industries by enabling computers to learn from data and make intelligent decisions autonomously. These technologies encompass a broad spectrum of techniques, ranging from traditional statistical methods to cutting-edge deep learning algorithms, all aimed at extracting patterns and insights from vast datasets. Applications of machine learning and AI span diverse domains such as healthcare, finance, automotive, and manufacturing, promising enhanced efficiency, accuracy, and innovation. Despite the remarkable progress, challenges persist in optimizing model performance, ensuring fairness and transparency, and addressing ethical considerations, underscoring the ongoing need for innovation in this dynamic field.

### SUMMARY

The following is a non-exhaustive listing of some aspects of the present techniques. These and other aspects are described in the following disclosure. Some aspects include a method including: obtaining time-series data; computing a transform of the time-series data; performing, with a complex clipping algorithm, a complex clipping operation of the transform of the time-series data to obtain a clipped data representation of the transform; classifying, using a classifier, the time-series data based on the clipped data representation; and storing a result of the classifying in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram illustrating an example of a data classification system, in accordance with some embodiments of the present disclosure;

FIG. 2 is a block diagram illustrating an example of a time-series data processing computing device of the data classification system of FIG. 1, in accordance with some embodiments of the present disclosure;

FIG. 3 is a flow diagram illustrating an example of a method of the data classification system, in accordance with some embodiments of the present disclosure;

FIG. 4 is a flow diagram illustrating a complex clipping graph, in accordance with some embodiments of the present disclosure;

FIG. 5 is a block diagram of an example of a computing system with which the present techniques may be implemented, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of machine learning, time-series data processing, acoustic data management, and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

These techniques may be implemented on a collection of computing devices (like on a smartphone processor and/or server processor (e.g., connected to the smartphone via the Internet), running code stored in tangible, non-transitory, computer readable media (e.g., in memory, or distributed among a collection of storage devices of computing devices that execute different subsets of the code to implement a distributed application) to effectuate the techniques described. Embodiments include systems, methods, and media storing code that train models in the manner described and systems, methods, and media that use those trained models to process out-of-sample data to classify new time-series data such as cough audio absent from the training sets.

These techniques may be implemented in conjunction with, and the corresponding code executed on, the systems described in U.S. patent application Ser. No. 17/393,113, titled ENSEMBLE MACHINE-LEARNING MODELS TO DETECT RESPIRATORY SYNDROMES, filed 3 Aug. 2021, the contents of which are hereby incorporated by reference. Some embodiments may transform acquired audio with the techniques described below, e.g., in a data processing pipeline, upstream of (or inserted within) the classification models described in the material incorporated by reference. These materials are incorporated, however, only to the extent that no conflict exists between such material and the statements and drawings set forth herein. In the event of such conflict, the text of the present document governs, and terms in this document should not be given a narrower reading in virtue of the way in which those terms are used in other materials incorporated by reference, nor should any disclaimers or disavowals be read into the present filing from the materials incorporated by reference or the materials that follow (e.g., discussion of challenges with linear dependencies within network layers should not be read as disavowal or disclaimer of systems exhibiting such behavior). Other embodiments may use the techniques described in the following paper for other use cases, e.g., examples of which are described in U.S. Provisional Patent Application 63/348,772, titled CLASSIFYING AUDIO FROM LIVING ORGANISMS WITH MACHINE LEARNING, filed 3 Jun. 2022, the contents of which are hereby incorporated by reference.

Many modern systems for classification and estimation make use of deep networks. These trainable systems are typically overparameterized, with many more network parameters (weights and biases) than training examples. Due to this overparameterization, deep networks have many “critical points,” which may, for example, be local minima or saddle points. During training, these critical points are singularities in neural networks that often detract from learning, as singularities do for other ill-posed training examples. As such, singular behavior within neural networks has been a rich topic of recent research. For example, methods to regularize and reduce their prevalence, methods to avoid singularities within the network, and the effect of these singularities on the dynamics of learning within multilayer perceptrons has been researched. Singularities should be avoided or ameliorated by reducing the possibility of linear dependencies within network layers. These linear dependencies can cause learning difficulties, such as non-smooth loss functions, where minimizers are not well-behaved; hence generalization becomes more difficult.

Embodiments of the present disclosure provide for improvements to linear dependencies in the input representation of the network. At first consideration, this reduction is a very difficult problem since most real-world time-series signals are flush with natural sources of linear dependencies. For example, acoustic propagation is subject to natural reverberation, and radio communication signals are subject to multipath, both of which introduce linear dependencies. Most pre-processing, such as changing sample rate and filtering, will also contribute to linear dependencies. Even the short-time Fourier transform, with its usual overlap/add processing, has implicit linear dependencies between frequency channels. The systems and methods of the present disclosure do not model those linear dependencies, but rather reduce linear dependencies by carefully considering and modifying the usual input processing of acoustic and similar signals.

Many deep nets systems have inputs from Fourier transforms, such as spectrograms, Mel-frequency spectral coefficients, and other frequency representations of real sequences. These representations usually use real numbers that arise from usual magnitude operations on initial short-time Fourier transforms, which are typically complex-valued. This conversion from complex values to real numbers, and possible small extra processing to remove linear dependencies and hence singularities is provided by the systems and methods discussed herein. Embodiments of the present disclosure provide modifications to standard magnitude detection, as used, for example, in converting the complex output of a short-time Fourier transform to a non-negative real spectrogram, which may remove much of the linear dependence in training and test data.

As such, the systems and methods of the present disclosure remove this deleterious linear dependence in spectrograms and similar deep net input representations—while retaining all remaining independent information encoded by the spectrogram. Furthermore, this new form of regularization produces improved conditioning—that is shown via improved condition numbers of the input arrays, and substantially improved generalization performance on a real-world example of a noisy and important data application.

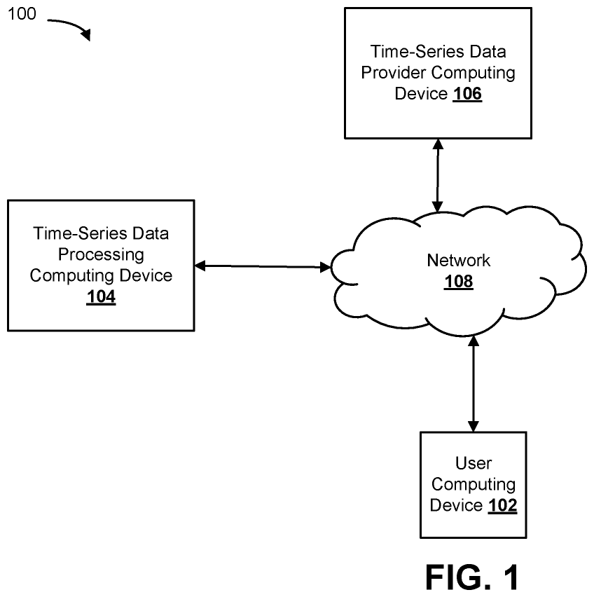

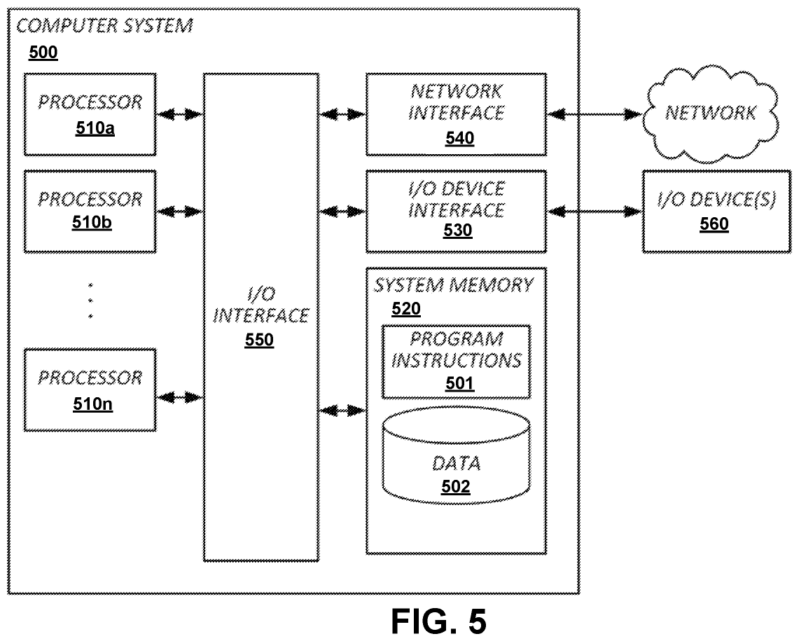

FIG. 1 depicts a block diagram of an example of a data classification system 100, consistent with some embodiments. In some embodiments, the data classification system 100 may include a user computing device 102, a time-series data processing computing device 104, and a time-series data provider computing device 106. The user computing device 102 and the time-series data processing computing device 104 may be in communication with each other over a network 108. In various embodiments, the user computing device 102 may be associated with a user (e.g., in memory of the data classification system 100 in virtue of user profiles). These various components may be implemented with computing devices like shown in FIG. 5.

In some embodiments, the user computing device 102 may be implemented using various combinations of hardware or software configured for wired or wireless communication over the network 108. For example, the user computing device 102 may be implemented as a wireless telephone (e.g., smart phone), a tablet, a personal digital assistant (PDA), a notebook computer, a personal computer, a connected set-top box (STB) such as provided by cable or satellite content providers, or a video game system console, a head-mounted display (HMD), a watch, an eyeglass projection screen, an autonomous/semi-autonomous device, a vehicle, a user badge, or other user computing devices. In some embodiments, the user computing device 102 may include various combinations of hardware or software having one or more processors and capable of reading instructions stored on a tangible non-transitory machine-readable medium for execution by the one or more processors. Consistent with some embodiments, the user computing device 102 may include a machine-readable medium, such as a memory that includes instructions for execution by one or more processors for causing the user computing device 102 to perform specific tasks. In some embodiments, the instructions may be executed by the one or more processors in response to interaction by the user. One user computing device is shown, but commercial implementations are expected to include more than one million, e.g., more than 10 million, geographically distributed over North America or the world.

The user computing device 102 may include a communication system having one or more transceivers to communicate with other user computing devices or the time-series data processing computing device 104. Accordingly, and as disclosed in further detail below, the user computing device 102 may be in communication with systems directly or indirectly. As used herein, the phrase “in communication,” and variants thereof, is not limited to direct communication or continuous communication and may include indirect communication through one or more intermediary components or selective communication at periodic or aperiodic intervals, as well as one-time events.

For example, the user computing device 102 in the data classification system 100 of FIG. 1 may include a first (e.g., relatively long-range) transceiver to permit the user computing device 102 to communicate with the network 108 via a communication channel. In various embodiments, the network 108 may be implemented as a single network or a combination of multiple networks. For example, in various embodiments, the network 108 may include the Internet or one or more intranets, landline networks, wireless networks, or other appropriate types of communication networks. In another example, the network 108 may comprise a wireless telecommunications network adapted to communicate with other communication networks, such as the Internet. The wireless telecommunications network may be implemented by an example mobile cellular network, such as a long-term evolution (LTE) network or other third generation (3G), fourth generation (4G) wireless network, fifth generation (5G) wireless network or any subsequent generations. In some examples, the network 108 may be additionally or alternatively be implemented by a variety of communication networks, such as, but not limited to (which is not to suggest that other lists are limiting), a satellite communication network, a microwave radio network, or other communication networks.

The user computing device 102 additionally may include a second (e.g., short-range relative to the range of the first transceiver) transceiver to permit the user computing device 102 to communicate with each other or other user computing devices via a direct communication channel. Such second transceivers may be implemented by a type of transceiver supporting short-range (i.e., operate at distances that are shorter than the long-range transceivers) wireless networking. For example, such second transceivers may be implemented by Wi-Fi transceivers (e.g., via a Wi-Fi Direct protocol), Bluetooth® transceivers, infrared (IR) transceivers, and other transceivers that are configured to allow the user computing device 102 to communicate with each other or other user computing devices via an ad-hoc or other wireless network.

The data classification system 100 may also include or may be in connection with the time-series data processing computing device 104. For example, the time-series data processing computing device 104 may include one or more server devices, storage systems, cloud computing systems, or other computing devices (e.g., desktop computing device, laptop/notebook computing device, tablet computing device, mobile phone, etc.). In various embodiments, time-series data processing computing device 104 may also include various combinations of hardware or software having one or more processors and capable of reading instructions stored on a tangible non-transitory machine-readable medium for execution by the one or more processors. Consistent with some embodiments, the time-series data processing computing device 104 may include a machine-readable medium, such as a memory (not shown) that includes instructions for execution by one or more processors (not shown) for causing the time-series data processing computing device 104 to perform specific tasks. In some embodiments, the instructions may be executed by the one or more processors in response to interaction by the user. The time-series data processing computing device 104 may also be maintained by an entity with which sensitive credentials and information may be exchanged with the user computing device 102. The time-series data processing computing device 104 may further be one or more servers that host applications for the user computing device 102. The time-series data processing computing device 104 may be more generally a web site, an online content manager, a service provider, a healthcare provider, an audio provider, a machine repair provider (e.g., a mechanic, a technician, etc.), a datacenter management system, or other entity that generates or uses time-series data from which classification or predictions may be made.

The time-series data processing computing device 104 may include various applications and may also be in communication with one or more external databases, that may provide additional information or data objects that may be used by the time-series data processing computing device 104. For example, the time-series data processing computing device 104 may obtain, via the network 108, time-series data from a time-series data provider computing device 106 that may obtain or generate time-series data such as acoustic content, electrical data, sensor data, or other time-series data that would benefit from the teaching of the present disclosure that would be apparent from one of skill in the art in possession of the present disclosure for the time-series data processing computing device 104. While a specific data classification system 100 is illustrated in FIG. 1, one of skill in the art in possession of the present disclosure will recognize that other components and configurations are possible, and thus will fall under the scope of the present disclosure.

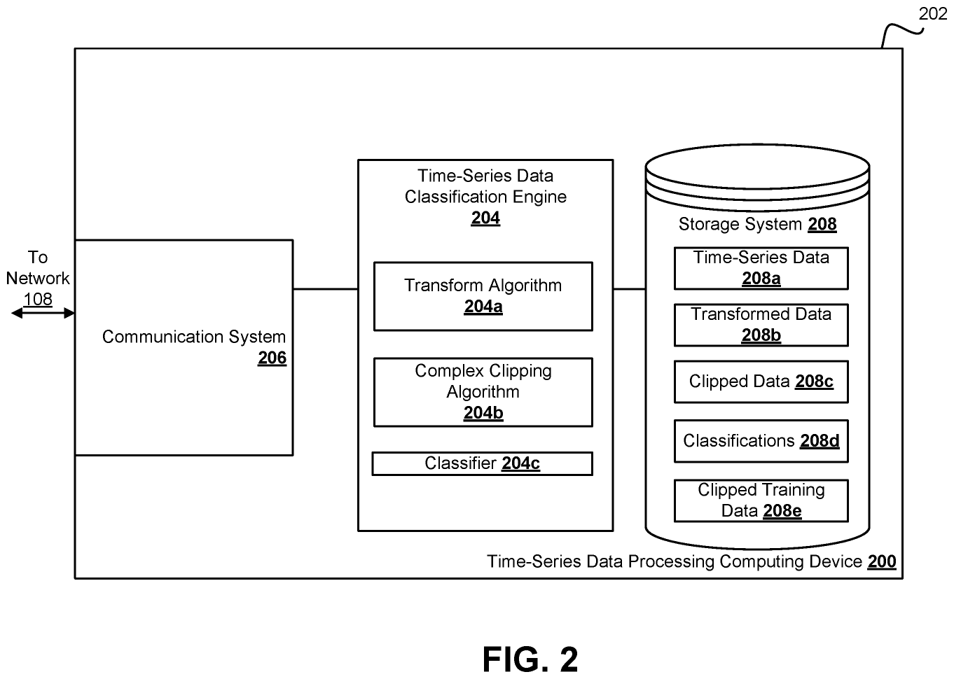

FIG. 2 depicts an embodiment of a time-series data processing computing device 200, which may be the time-series data processing computing device 104 discussed above with reference to FIG. 1. In the illustrated embodiment, the time-series data processing computing device 200 includes a chassis 202 that houses the components of the time-series data processing computing device 200, only some of which are illustrated in FIG. 2. For example, the chassis 202 may house a processing system (not illustrated) and a non-transitory memory system (not illustrated) that includes instructions that, when executed by the processing system, cause the processing system to provide a time-series data classification engine 204 that is configured to perform the functions of the time-series data classification engines or the time-series data processing computing devices discussed below. Specifically, the time-series data classification engine 204 may process and classify time-series data (e.g., acoustic data, sensor data, or other time-series data) as discussed in further detail below. The time-series data classification engine 204 may be configured to obtain time-series data from the time-series data provider computing device 106, classify time-series data, and provide the classification over the network 108 to a web browser application or a native application included on the user computing device 102 of FIG. 1. For example, the user of the user computing device 102/200 may interact with the time-series data classification engine 204 over the network 108 to request information, conduct a commercial transaction, send or receive email communications, store or retrieve data, obtain a classification, obtain errors, issues, or a status of a person, an animal, or a machine, receive a prediction of a parameter for which a machine learning algorithm is predicting, or otherwise interact with the time-series data classification engine 204.

The processing system and the non-transitory memory system may also include instructions that, when executed by the processing system, cause the processing system to provide a transform algorithm 204a that is configured to perform the functions of the transform algorithms or the time-series data processing computing devices discussed below. For example, the transform algorithm 204a may compute a transform (e.g., a type of Fourier transform), as discussed in further detail below. The processing system and the non-transitory memory system may also include instructions that, when executed by the processing system, cause the processing system to provide a complex clipping algorithm 204b that is configured to perform the functions of the complex clipping algorithms or the time-series data processing computing devices discussed below. For example, the complex clipping algorithm 204b may clip portions of the transform based on a clipping condition, as discussed in further detail below. The processing system and the non-transitory memory system may also include instructions that, when executed by the processing system, cause the processing system to provide a classifier 204c (e.g., a machine learning algorithm) that is configured to perform the functions of the classifiers or the time-series data processing computing devices discussed below. For example, the classifier 204c may be trained based on clipped training data to classify the clipped transform of the time-series data, as discussed in further detail below.

The chassis 202 may further house a communication system 206 that is coupled to the time-series data classification engine 204 (e.g., via a coupling between the communication system 206 and the processing system) and that is configured to provide for communication through the network 108 of FIG. 1 as detailed below. The communication system 206 may allow the time-series data processing computing device 200 to send and receive information over the network 108 of FIG. 1. The chassis 202 may also house a storage device (not illustrated) that provides a storage system 208 that is coupled to the time-series data classification engine 204 through the processing system. The storage system 208 may be configured to store a time-series data 208a, transformed data 208b, clipped data 208c, classifications 208d, clipped training data 208c, or other data or instructions to complete the functionality discussed herein. In various embodiments, the storage system 208 may be provided on the time-series data processing computing device 200 or on a database accessible via the communication system 206. Furthermore, while the time-series data classification engine 204 is illustrated as being located on the time-series data processing computing device 104/200, the time-series data classification engine 204 may be included on the time-series data provider computing device 106 of FIG. 1. For example, the time-series data classification engine 204 may obtain the time-series data or a portion of the time-series data from the time-series data provider computing device 106 rather than generate the time-series data completely itself. While a time-series data processing computing device 102/200 is illustrated in FIG. 1, one of skill in the art in possession of the present disclosure will recognize that other components and configurations are possible, and thus will fall under the scope of the present disclosure.

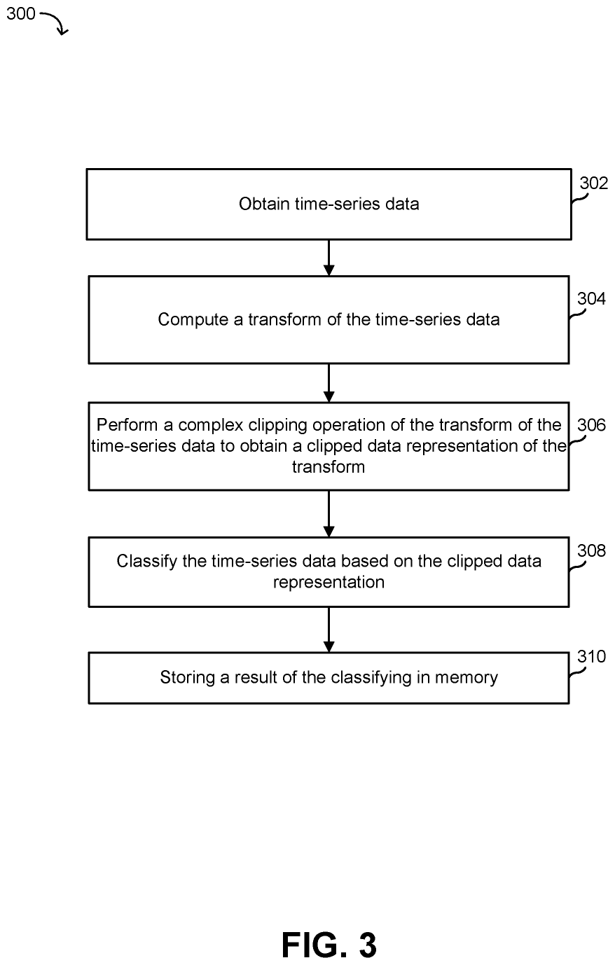

FIG. 3 depicts an embodiment of a method 300 of time-series data classification, which in some embodiments may be implemented with the components of FIGS. 1 and 2 discussed above. As discussed below, some embodiments make technological improvements to time-series data analysis and machine learning classifications or predictions using time-series data. In a variety of scenarios, the systems and methods of the present disclosure may be useful to draw inferences from a time-series data like acoustic data to determine a source of a noise, a condition relating to a source of a noise, or other classification or prediction that may be apparent ton one of skill in the art in possession of the present disclosure. Examples include inferring: a medical condition based on a patient's cough, a type of watercraft based on underwater audio recordings, a type of aircraft based on audio recordings or sonar data, a security event based on audio data in a security system, a diagnosis based on electrocardiogram readings or a electroencephalogram, diagnostics of an engine based on obtained acoustic data, or other inferences. One of skill in the art in possession of the present disclosure will recognize that these Internet-centric and technological-based problems, along with other Internet-centric and technological-based problems, are solved or mitigated by some of these embodiments. Again, though, embodiments are not limited to approaches that address these problems, as various other problems may be addressed by other aspects of the present disclosure, which is not to suggest that any other description is limiting.

The method 300 is described as being performed by the time-series data classification engine 204 included on the time-series data processing computing device 104/200. Furthermore, it is contemplated that the user computing device 102 or the time-series data provider computing device 106 may include some or all the functionality of the time-series data classification engine 204. As such, some or all of the steps of the method 300 may be performed by the user computing device 102 or the time-series data provider computing device 106 and still fall under the scope of the present disclosure. As mentioned above, the time-series data processing computing device 104/200 may include one or more processors or one or more servers, and thus the method 300 may be distributed across the those one or more processors or the one or more servers.

The method 300 may begin at block 302 where time-series data is obtained. In an embodiment, at block 302, the time-series data classification engine 204 may obtain a data set that includes time-series data 208a. The time-series data 208a, which may also be described as time domain data herein, may include at least a two-dimensional data set where at least one of the dimensions is based on time. The other dimension may be based on some other unit of measurement or amplitude (e.g., pressure, temperature, decibels, voltage, current, or the like).

The time-series data classification engine 204 may obtain time-series data 208a from various sources. For example, the time-series data classification engine 204 may obtain the time-series data 208a from the time-series data provider computing device 106. Specifically, the time-series data classification engine 204 may interact with the time-series data provider computing device 106 via a single application programming interface (API) that allows the time-series data classification engine 204 to interact with one or more applications on the time-series data provider computing device 106 that may provide one or more time-series data 208a to the time-series data classification engine 204. However, multiple APIs may be used and included at the time-series data classification engine 204 to interact with the applications provided by the time-series data provider computing device 106. In various embodiments, the time-series data may be obtained from sensors coupled to the time-series data classification engine 204 either via the network 108 and the communication system 206 or via a local coupling. As such, the chassis 202 may house a sensor system (e.g., a microphone, a thermometer, a barometer, a hydrophone, an inertial measurement unit, a camera, or other sensors that would be apparent to one of skill in the art. The time-series data 208a may be generated or obtained and may be stored in the storage system 208.

The method 300 may then proceed to block 304 where a transform of the time-series data is computed. In an embodiment, at block 304, the time-series data classification engine 204 may compute a transform of the time-series data using the transform algorithm 204a. In various embodiments, the transform algorithm 204a is a Fourier transform that transforms the time-series data from the time domain to a frequency domain. In more particular examples, the transform is a short-time Fourier transform (STFT). A conventional approach to classification of acoustic and similar signals with deep nets has predominantly used time frequency representations such as spectrograms. Spectrograms may be found via a detection operation on a short time Fourier transforms, often defined with a mixed discrete time (n ∈ [symbol] ) and discrete frequency (k ∈ [symbol] ) notation as

$$X [ n , k ] = {\sum }_{m = 0}^{K - 1} w [ m ] x [ m + nH ] {e}^{- j \frac{2 π}{K} km} ,$$

There may be L input points x ∈ [symbol] ^{L} available for each overall STFT calculation, which produces a matrix of complex values of size (K/2)χ(M+1), where only non-negative frequency indices may be used. The complete STFT input may use a sequence of M shifting steps, called “frames,” which shift over x. H is the amount of shift, often called “hop size.” The data window is optionally weighted by a tapered window w[n] of length K. (Mel-spaced spectrograms and Mel frequency cepstral coefficients may modify this representation by using non-uniform spacing in k.) This STFT uses the above Fourier sum to map typically real one-dimensional values to complex 2-dimensional values

$${ℝ}^{L} \to {ℂ}^{( \frac{K}{2} ) ( M + 1 )} .$$

Typically, (K/2)×(M+1) is greater than or much greater than the size of the input x, which is L sequential points. Thus, the STFT's real to complex mapping is typically heavily redundant. While the STFT is usually a beneficial step for machine learning since it breaks the input into frequency channels, this benefit potentially comes with the cost of added redundancy. It would thus be expected that deleterious linear dependence is already within the input x and is also potentially increased by the STFT. It is also clear that these processing parameters can influence the linear dependence between values of X[n,k], which suggests that operations on X[n,k] are a particularly good place to remove this deleterious dependence.

The STFT may be used as a precursor to a spectrogram. To make use of existing successful deep net architectures and other classifiers, a STFT may need a detection operation to form the non-negative real values of a spectrogram

$${ℂ}^{( \frac{K}{2} ) ( M + 1 )} \to {ℝ}^{( \frac{K}{2} ) ( M + 1 )} ,$$

where [symbol] ₊, are non-negative real numbers, via a magnitude square |X[n, k]|², usually followed by a scaled logarithm, providing the common 2-dimensional spectrogram in decibels. Without loss of generality, this scaling factor may equate magnitude square and magnitude (rectification) detection. However, the transform algorithm 204a of the present disclosure may generalize this magnitude square detection operation in such a way that it removes linear dependence. As with the usual magnitude square for the spectrogram, the detection operation may map a complex range to a continuous non-negative real range f(X,[n,k]), [symbol] → [symbol] ₊.

This STFT detection may have similarities with activation functions in deep nets. A common activation, ReLU (rectified linear unit) activation function may be defined as g(x)=max(0,x), [symbol] → [symbol] ₊ where x may be a real input to the activation function. (Consideration of complex inputs is discussed below). ReLU activation function may have advantages over other smooth activation functions such as sigmoid shapes. Like a magnitude or magnitude-squared detector of a spectrogram, a ReLU may map to non-negative real numbers. Some of the benefits of the ReLU function over the deep net activation functions may include (1) better performance, especially when combined with dropout regularization, (2) reduction of linear dependence, (3) reduction of vanishing gradients, and (4) dispersion of sparse codes, as well as other benefits that would be apparent to one of skill in the art in possession of the present disclosure.

The method 300 may proceed to block 306 where a complex clipping operation of the transform of the time-series data to obtain a clipped data representation of the transform. In an embodiment, at block 306, the time-series data classification engine 204 may operate the complex clipping algorithm 204b to clip the transformed data 208b to clipped data 208c. For example, the time-series data classification engine 204 may keep two-dimensional spectrogram points when a magnitude of an imaginary part of the STFT is less than a magnitude of a real part of the STFT:

$${\vert Y [ n , k ] \vert}^{2} = f ( X [ n , k ] ) = {\vert X [ n , k ] \vert}^{2} ,$$

$$If \vert Im \{ X [ n , k ] \} \vert \leq \vert Re \{ X [ n , k ] \} \vert$$

The complex clipping algorithm 204b may then clip or set all other two-dimensional spectrogram points to zero or substantially zero (e.g., zero, 100 magnitudes less than the smallest kept number, 1,000 magnitudes less than smallest kept number, 100,000 magnitudes less than the smallest kept number, or other magnitudes that would be apparent to one of skill in the art in possession of the present disclosure such that the two-dimensional spectrogram substantially zero:

$${\vert Y [ n , k ] \vert}^{2} = f ( X [ n , k ] ) = 0 ,$$

$$If \vert Im \{ X [ n , k ] \} \vert > \vert Re \{ X [ n , k ] \} \vert$$

As complex clipping scales to analyze large volumes of time-series data, comparing the magnitude of real and imaginary components for each point in the STFT could become computationally taxing. However, the parallelizability of these magnitude checks presents an opportunity. By utilizing massively parallel architectures, the STFT vector space may be distributed across many concurrent processors (e.g., central processing units (CPUs) and machines. Each processor handles localized subsets of the real-imaginary plane using a UUID (Universal Unique Identifier) or a hash key for each subset, evaluating the complex clipping constraints of comparing the real and the imaginary component of each point simultaneously in a divide-and-conquer approach. Under the hood, this partitioning of the coordinate space into smaller zones assigns each processor an independent group of complex values for localized checking. With MPP (massively parallel processing) frameworks such as Apache Spark or Apache Beam to manage the parallel execution, substantial speedups are attainable compared to sequential processing. In essence, parallelization meshes with the complex clipping technique, overcoming any latency bottlenecks while retaining analytic precision.

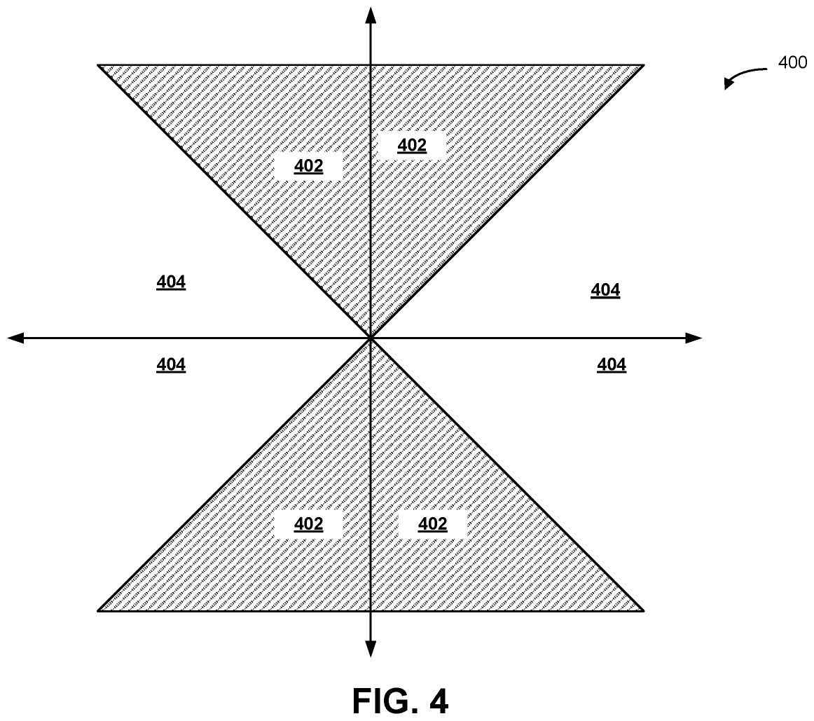

FIG. 4 illustrates a graph 400 of the set to zero complex clipping support region of f(x[n,k]). As illustrated by FIG. 4, the x-axis is Re{X[n,k]}(the real part of the STFT) and the y-axis is Im{X[n,k]} (the imaginary part of the STFT). The equations above produce a set value to zero area 402 and a retain value area 404. Because the upper/lower and left/right symmetry implies that the set value to zero area 402 is redundant with the retain value area 404, an equivalent regularization would be an

$$ϕ = \frac{π}{2}$$

rotation of the cone shape implied by the equations above, becoming:

$${\vert Y [ n , k ] \vert}^{2} = f ( X [ n , k ] ) = {\vert X [ n , k ] \vert}^{2} ,$$

$$If \vert Im \{ X [ n , k ] \} \vert > \vert Re \{ X [ n , k ] \} \vert$$

$${\vert Y [ n , k ] \vert}^{2} = f ( X [ n , k ] ) = 0 ,$$

$$If \vert Im \{ X [ n , k ] \} \vert \leq \vert Re \{ X [ n , k ] \} \vert$$

While specific equations and complex clipping is described, deviations or variations of the equations may be contemplated by a person of skill in the art and still provide improvements over conventional systems and fall under the scope of the present disclosure. For example, desirable, but not limiting, properties for a non-negative real mapping f(X[n,k]) from a STFT X[n,k] to a non-negative real deep net input Y[n,k] are f(X[n,k]) is (1) nonlinear and bounded, (2) is upper/lower and right left/symmetric, (3) has minimal non-zero support area, and (4) retains zero-crossings.

The method 300 may proceed to block 308 where the time-series data is classified based on the clipped data representation. In an embodiment, at block 308, the time-series data classification engine 204 may utilize the classifier 204c to determine a classification for the time-series data 208a using the clipped data 208c. In some embodiments, the classifier 204c may include a machine learning model (e.g., a deep neural network or other neural networks, a gradient boosting machine (GBM) model, a tree-based model, or other machine learning models that would be apparent to one of skill in the art in possession of the present disclosure) provided by the time-series data classification engine 204. The machine learning model may include a mechanism for classifying the clipped training data 208e. The machine learning model may be trained with clipped data and may be trained using one or more graphics processing unit (GPU) while the complex clipping may be performed by one or more CPUs. GPUs may accelerate training using lower numeric precision capabilities and small batches of data further speed up training. Furthermore, the machine learning model may operate on the clipped data 208c using one or more application specific integrated circuits (ASIC) such as a tensor processing unit (TPU). The simplified design of these integrated circuits enables fast real-time predictions/classifications. As such the various processing units may utilize massively parallel processing (MPP) techniques.

The method 300 may proceed to block 310 where an action is performed with a result of the classification. In an embodiment, at block 310, the time-series data classification engine 204 may store the result of the classification. For example, the time-series data classification engine 204 may store the classification 208d in the storage system 208. In other examples, the classification may be provided to the user computing device 102 via the communication system 206 and network 108 to satisfy any request or to provide a notification of the classification based on a classification condition being satisfied. In other embodiments, the time-series data classification engine 204 or other applications operated by the time-series data processing computing device 200 or the user computing device 102 may use the classification for various purposes that would be apparent to one of skill in the art in possession of the present disclosure.

An example use of the method 300 with the activation function of complex clipping is to classify cough audio data to determine an associated disease such as COVID-19, flu, tuberculosis COPD, asthma, lung cancer or other diseases that would be apparent to one of skill in the art in possession of the present disclosure. Classifier training inputs may include sound recordings for COVID-19 patients of all ages, in various settings, symptomatic and asymptomatic, and at different periods relative to symptom onset. These allow the trained deep net algorithms to learn audio characteristics of COVID-19 illness in patients with various demographic and medical conditions. A potential, purely digital COVID-19 detection method may allow for a smartphone-based rapid, equitable COVID-19 test with minimal infection risk, economic burden, and supply chain issues—all helpful factors to controlling COVID-19 spread.

While working with various data sets for training, testing, and validation, the inventors of the present disclosure selected a challenging data set of recorded coughs collected by a large medical insurance company by making phone calls to patients tested by PCR techniques for COVID-19. Most of these audio files were each under 4 seconds long. All data were zero-padded and truncated to an identical length of 4 seconds to set a fixed deep net input size. This data set, consisting of 7358 separate audio files, had a range of signal-to-noise (SNR) ratios of −10 to 28 dB. Only samples with an estimated SNR higher than 15 dB were kept, simulating a practical system which rejects unacceptably noisy inputs.

The deep net architecture spectrogram parameter choices were trained and tested, with no change to the usual dB encoding of spectrograms, as labeled by |X [n, k]|² in the above equations and the results were compared to Y[n,k]. With the cone boundary the same but the non-zero region rotated by

$$ϕ = \frac{π}{2} ,$$

resulted in very similar improvement even though the retained points are completely different.

For both the complex clipped spectrogram and the rotated version, the area under a receiver operating curve improved from 0.77 to 0.93 after complex clipping. This difference is potentially substantial for some applications. The performance curves of the complex clipped spectrogram and the rotated version were very close to each other, yet were not identical. The inventors also found that empirical estimates of singular values of unprocessed versus complex clipped spectrograms showed that most estimated singular values, other than the largest singular value, were virtually unchanged by the non-linearity. However the largest singular value was reduced by about 70%, suggesting that conditioning of the resulting Y[n,k] representation was greatly improved, indicating that the proposed complex clipping effects a potentially useful regularization of the deep net at the input.

Thus, the systems and methods of the present disclosure provide complex clipping for improved generalization in machine learning. Time-series data may be transformed into the frequency domain and then clipped removing some of the transformed data using a complex clipping algorithm. The clipped data may then be inputted into a classifier that may classify the time-series data. As such, the systems and methods of the present disclosure improve the technical area of machine learning by making machine learning more efficient and accurate as well as scaling for parallel processing of data sets and requiring less computation processing due to the fewer data points operated on by the machine learning algorithm or other classifier.

FIG. 5 is a diagram that illustrates a computing system 500 in accordance with embodiments of the present technique. The user computing device 102 and 200, the time-series data processing computing devices 104 and 200, and the time-series data provider computing device 106, discussed above, may be provided by the computing system 500. Various portions of systems and methods described herein, may include or be executed on one or more computing systems similar to computing system 500. Further, processes and modules described herein may be executed by one or more processing systems similar to that of computing system 500.

Computing system 500 may include one or more processors (e.g., processors 510a-510n) coupled to system memory 520, an input/output I/O device interface 530, and a network interface 540 via an input/output (I/O) interface 550. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 500. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 520). Computing system 500 may be a uni-processor system including one processor (e.g., processor 510a), or a multi-processor system including any number of suitable processors (e.g., 510a-510n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 500 may include a plurality of computing devices (e.g., distributed computing systems) to implement various processing functions.

I/O device interface 530 may provide an interface for connection of one or more I/O devices 560 to computing system 500. I/O devices may include devices that receive input (e.g., from a user) or output information (e.g., to a user). I/O devices 560 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 560 may be connected to computing system 500 through a wired or wireless connection. I/O devices 560 may be connected to computing system 500 from a remote location. I/O devices 560 located on remote computing system, for example, may be connected to computing system 500 via a network and network interface 540.

Network interface 540 may include a network adapter that provides for connection of computing system 500 to a network. Network interface 540 may facilitate data exchange between computing system 500 and other devices connected to the network. Network interface 540 may support wired or wireless communication. The network may include an electronic communication network, such as the Internet, a local area network (LAN), a wide area network (WAN), a cellular communications network, or the like.

System memory 520 may be configured to store program instructions 501 or data 502. Program instructions 501 may be executable by a processor (e.g., one or more of processors 510a-510n) to implement one or more embodiments of the present techniques. Instructions 501 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 520 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM or DVD-ROM, hard-drives), or the like. System memory 520 may include a non-transitory computer readable storage medium that may have program instructions stored thereon that are executable by a computer processor (e.g., one or more of processors 510a-610n) to cause the subject matter and the functional operations described herein. A memory (e.g., system memory 520) may include a single memory device or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 550 may be configured to coordinate I/O traffic between processors 510a-510n, system memory 520, network interface 540, I/O devices 560, or other peripheral devices. I/O interface 550 may perform protocol, timing, or other data transformations to convert data signals from one component (e.g., system memory 520) into a format suitable for use by another component (e.g., processors 510a-510n). I/O interface 550 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 500 or multiple computing systems 500 configured to host different portions or instances of embodiments. Multiple computing systems 500 may provide for parallel or sequential processing/execution of one or more portions of the techniques described herein.

Those skilled in the art will appreciate that computing system 500 is merely illustrative and is not intended to limit the scope of the techniques described herein. Computing system 500 may include any combination of devices or software that may perform or otherwise provide for the performance of the techniques described herein. For example, computing system 500 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 500 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computing system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 500 may be transmitted to computing system 500 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computing system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A non-transitory, machine-readable medium storing instructions that, when executed by one or more processors, effectuate operations comprising: obtaining, with a computer system, time-series data; computing, with the computer system, a transform of the time-series data; performing, with the computer system and a complex clipping algorithm, a complex clipping operation of the transform of the time-series data to obtain a clipped data representation of the transform; classifying, with the computer system and using a classifier, the time-series data based on the clipped data representation; and storing, with the computer system, a result of the classifying in memory.
2. The non-transitory, machine-readable medium of embodiment 1, wherein the time-series data includes audio data.
3. The non-transitory, machine-readable medium of embodiment 2, wherein the audio data includes cough, speech, or breathing audio data.
4. The non-transitory, machine-readable medium of any one of embodiments 1-3, wherein the classifier includes a machine learning algorithm.
5. The non-transitory, machine-readable medium of embodiment 4, wherein the machine learning algorithm is trained using a training set of clipped data representations.
6. The non-transitory, machine-readable medium of any one of embodiments 4-5, wherein the machine learning algorithm is trained using one or more graphics processing units, the complex clipping algorithm is executed using one or more central processing units, and the machine learning algorithm is executed using one or more tensor processing units.
7. The non-transitory, machine-readable medium of any one of embodiments 4-6, wherein the machine learning algorithm includes a deep neural network.
8. The non-transitory, machine-readable medium of any one of embodiments 1-7, wherein the transform is a short-time Fourier transform (STFT) having an imaginary part and a real part.
9. The non-transitory, machine-readable medium of embodiment 8, wherein the complex clipping operation includes:
   retaining two-dimensional spectrogram points when a magnitude of the imaginary part of the STFT is less than a magnitude of the real part of the STFT; and
   setting all other two-dimensional spectrogram points to substantially zero.
10. A method comprising any one of the embodiments 1-9.
11. A system, comprising: one or more processors; and memory storing instructions that when executed by the one or more processors cause the one or more processors to effectuate operations comprising any one of the embodiments 1-9.

What is claimed is:

1. A non-transitory, machine-readable medium storing instructions that, when executed by one or more processors, effectuate operations comprising:
obtaining, with a computer system, time-series data;
computing, with the computer system, a transform of the time-series data;
performing, with the computer system and a complex clipping algorithm, a complex clipping operation of the transform of the time-series data to obtain a clipped data representation of the transform;
classifying, with the computer system and using a classifier, the time-series data based on the clipped data representation; and
storing, with the computer system, a result of the classifying in memory.

2. The non-transitory, machine-readable medium of claim 1, wherein the time-series data includes audio data.

3. The non-transitory, machine-readable medium of claim 2, wherein the audio data includes cough, speech, or breathing audio data.

4. The non-transitory, machine-readable medium of claim 1, wherein the classifier includes a machine learning algorithm.

5. The non-transitory, machine-readable medium of claim 4, wherein the machine learning algorithm is trained using a training set of clipped data representations.

6. The non-transitory, machine-readable medium of claim 4, wherein the machine learning algorithm is trained using one or more graphics processing units, the complex clipping algorithm is executed using one or more central processing units, and the machine learning algorithm is executed using one or more tensor processing units.

7. The non-transitory, machine-readable medium of claim 4, wherein the machine learning algorithm includes a deep neural network.

8. The non-transitory, machine-readable medium of claim 1, wherein the transform is a short-time Fourier transform (STFT) having an imaginary part and a real part.

9. The non-transitory, machine-readable medium of claim 8, wherein the complex clipping operation includes:
retaining two-dimensional spectrogram points when a magnitude of the imaginary part of the STFT is less than a magnitude of the real part of the STFT; and
setting all other two-dimensional spectrogram points to substantially zero.

10. A method, comprising:
obtaining, with a computer system, time-series data;
computing, with the computer system, a transform of the time-series data;
performing, with the computer system and a complex clipping algorithm, a complex clipping operation of the transform of the time-series data to obtain a clipped data representation of the transform;
classifying, with the computer system and using a classifier, the time-series data based on the clipped data representation; and
storing, with the computer system, a result of the classifying in memory.

11. The method of claim 10, wherein the time-series data includes audio data.

12. The method of claim 11, wherein the audio data includes cough, speech, or breathing audio data.

13. The method of claim 10, wherein the classifier includes a machine learning algorithm.

14. The method of claim 13, wherein the machine learning algorithm is trained using a training set of clipped data representations.

15. The method of claim 13, wherein the machine learning algorithm is trained using one or more graphics processing units, the complex clipping algorithm is executed using one or more central processing units, and the machine learning algorithm is executed using one or more tensor processing units.

16. The method of claim 13, wherein the machine learning algorithm includes a deep neural network.

17. The method of claim 10, wherein the transform is a short-time Fourier transform (STFT) having an imaginary part and a real part.

18. The method of claim 17, further comprising:
retaining two-dimensional spectrogram points when a magnitude of the imaginary part of the STFT is less than a magnitude of the real part of the STFT; and
setting all other two-dimensional spectrogram points to substantially zero.

19. A system, comprising: one or more processors; and memory storing instructions that when executed by the one or more processors cause the one or more processors to effectuate operations comprising:
obtaining time-series data;
computing a transform of the time-series data;
performing, with a complex clipping algorithm, a complex clipping operation of the transform of the time-series data to obtain a clipped data representation of the transform;
classifying, using a classifier, the time-series data based on the clipped data representation; and
storing a result of the classifying in memory.

20. The system of claim 19, wherein the one or more processors utilize massively parallel processing (MPP) techniques, and wherein the transform is a short-time Fourier transform (STFT) having an imaginary part and a real part and the operations further include:
retaining two-dimensional spectrogram points when a magnitude of the imaginary part of the STFT is less than a magnitude of the real part of the STFT; and
setting all other two-dimensional spectrogram points to substantially zero.
